(19) United States
(12) Patent Application Publication
(10) Pub. No.: US 2022/0024158 A1
(43) Pub. Date: Jan. 27, 2022

(54) DEVICE FOR PRESSING FLAT MATERIAL

(71) Applicants: AZL AACHEN GMBH, Aachen (DE); Rheinisch-Westfälische Technische Hochschule (RWTH) Aachen, Aachen (DE)

(72) Inventors: Albert Wendt, Hannover (DE); Michael Emonts, Aachen (DE); Richard Schares, Aachen (DE); Thomas Weiler, Aachen (DE)

(21) Appl. No.: 17/297,014

(22) PCT Filed: Nov. 27, 2019
(86) PCT No.: PCT/DE2019/101018

§ 371 Date: May 26, 2021

(30) Foreign Application Priority Data
Nov. 27, 2018 (DE) 10 2018 130 019.0

(51) Int. Cl. B29C 70/50; B29C 70/54; B29C 43/58; B29C 43/52; B29C 43/46; B29C 43/24; B27N 3/24

(52) U.S. Cl. CPC B29C 70/504; B29C 70/54; B29C 43/58; B29C 43/52; B29C 2043/461; B29C 43/245; B27N 3/24; B29C 2043/5808; B29C 43/46

(57) ABSTRACT

The invention relates to a device for pressing flat material, comprising means for transporting the flat material (15) in a transport direction and at least one pressing roller pair (9), which is stationary in the transport direction and acts on the flat material (15) on both sides, said device being characterized in that both pressing rollers (13, 14, 29, 34) of the pressing roller pair (9) or both pressing rollers (13, 14, 29, 34) of at least one of the pressing roller pairs (9) are elastically deformable in the radial direction at least at the circumference of said pressing rollers.

The invention relates to a device for pressing processing flat material according to the preamble of claim 1.

Such devices can be used, for example, for pressing processing, particularly for continuous lamination and/or impregnation of flat material lines or material segments. In this case, heating elements that heat the flat material for the pressing processing can also be provided. The device can be, for example, a double-belt press which is used, for example, for the production of fiber-reinforced plastics.

A device of the type mentioned at the beginning is known from EP 2 540 475 B1. This is a double-belt press in which two endless steel belts are driven and pressed against one another with their respective working strands, wherein the material to be processed is guided and pressed between the steel belts in the transport direction. The steel belts and thus indirectly the flat material to be pressed are heated for processing by means of inductive heating elements. The flat material is a composite material made of thermoplastic and filaments. In the transport direction behind the heating elements, a cooling unit comprising press rolls is provided, which presses on the top side and bottom side of the fiat material via the steel belts. Cooling water flows through at least one of the press rolls for the purpose of cooling. When using the double-belt press, the inductive heating elements encompass the two steel belts in the heating region. The heating elements are designed such that they comprise a lower half and an upper half which are temporarily separable from one another at connection points and thus allow an opening movement of the working strand of at least one of the steel belts. The press rolls create a line contact with the steel belt and thus an application of pressure that is very limited in time and place.

EP 0236905 B1 discloses a device for applying a surface pressure to advancing workpieces, which also constitutes a double-belt press. The pressing power is generated here by pressure plates which are arranged on both sides of the respective working strand of the press belts. The transport of the flat material is made possible by closed tracks of roller strands, which are guided between the respective pressure plate and the associated press belt, roll on the pressure plates and thereby transport the press belt and the workpiece clamped between the press belts. It is proposed that the rollers on each roller strand are positively and/or non-positively connected to one another, enclose an axle rod having a large annular gap exceeding a bearing play and are elastically deformable up to the axle contact on the axle rod. The elastic deformability of the rollers can compensate for tolerances. In addition, the aforementioned annular gap can have a heat-insulating effect to protect the axle rod if the pressure plates are heated or cooled. The way in which active heating could take place is not depicted in this prior art.

A double-belt press is known from DE 24 14 762 C2, in which a plurality of press roll pairs are provided, the gap distance of which can be varied, allowing the flat material to pass through. The gap distance is regulated via a pressure that is regulated by means of a pressure measuring device in a calibration section of the double-belt press. The steel belt can be heated by means of sliding shoes which slide on the respective steel belt and which are each arranged between two press roll pairs. The sliding shoes cause abrasion and thus increase the wear and tear on the double-belt press.

WO2010/031364 Al discloses a device for the production of composite material components, in which a rolling roller-shaped pressure unit having an elastically flexible pressure pad presses on the belt-shaped workpiece lying on a solid background, wherein the workpiece is heated with laser radiation immediately before being pressed on. A pressing roller pair having pressing rollers working against one another is not disclosed. Special measures are provided to protect the pressure pad from overheating by incident laser radiation, such as a material of the pressure pad that is (partially) transparent to laser radiation, a shadowing of the pressure pad against the laser radiation or a cooling fluid passed through the pressure pad. The elastic, flexible pressure pad is used here to compensate for height differences on three-dimensional workpiece surfaces when applying belt material.

The invention is based on the technical problem of providing a device of the type mentioned at the beginning which enables a more favorable pressure distribution of he pressing rollers acting on the flat material.

In a device of the type mentioned at the beginning, this object is achieved by the characterizing feature of claim 1. Preferred embodiments of the device according to the invention emerge from the dependent claims.

According to claim 1, a device for pressing processing flat material, comprising means for transporting the flat material in a transport direction and at least one pressing roller pair, which is stationary in the transport direction and acts on the flat material on both sides, said device being characterized in that both pressing rollers of the pressing roller pair or at least one of the pressing roller pairs are elastically deformable in the radial direction at least at the circumference of said pressing rollers.

Compared to the hard pressing rollers known from the prior art for stationary pressing roller pairs, the elastic deformability causes the press force to be distributed over a larger surface. Compared to the line contact known from known steel rolls or steel pressing rollers, said surface pressure results in an increased pressure application time and thus an improved and more homogeneous pressing effect.

Compared to the use of fluidic pressure pads, which can also create a flat pressure zone, the outlay on equipment is significantly lower and sealing systems that wear heavily are avoided. The likewise conceivable creation of flat pressure zones through the use of sliding plates would result in very limited process pressures and increased wear. According to the invention, on the other hand, surface pressure is made possible despite the rolling movement of the pressing rollers.

The device according to the invention can advantageously be designed such that there are at least two pressing roller pairs arranged one behind the other in the transport direction. The device according to the invention is particularly advantageous when it is designed as a double-belt press. In this case, the at least one pressing roller pair acts indirectly, namely via one of the belts on the flat material. The elastic deformability of the rollers of the at least one pressing roller pair is gentle on the belts used, without losing the advantage of surface pressure compared to pure line contact. In the case of the double-belt press, in which at least one of the belts is usually driven, the belt pair and the at least one pressing roller pair form the means for transporting the flat material to be processed.

The device according to the invention can also comprise at least one heating element for heating the flat material. Heating elements are typically used for producing composite materials or for lamination. One or more heating elements can be useful for the invention. Even when the heating elements are mostly mentioned in the plural in the following presentation of the invention for linguistic simplification, the invention also relates to corresponding design variants having only one heating element.

In the case of a double-belt press, the heating elements can act indirectly on the flat material via the belts of the double-belt press. Inductive heating is preferably used. One or a plurality of inductors are preferably arranged on both sides of the flat material, in the case of the double-belt press, on both sides of the working strands of the press belts.

The device according to the invention can also be designed such that at least a number of the heating means are designed to generate magnetic fields which have a predominant magnetic field component oriented perpendicular to a center plane of the flat material. This can be implemented by means of a flat inductor having a corresponding effect or a similarly constructed inductor with a corresponding effect. For example, it can be provided that the heating means or at least a number of the heating means have a meandering course at least in some sections. The meandering course can be aligned such that the loops of the meander run parallel to the center plane of the flat material to be heated during use.

Furthermore, it can be provided that at least a number of the heating means are designed to encompass a section of the flat material to be heated in a U-shape. In this case, the inductors can be designed such that they can be pushed into a working position over a longitudinal side of the flat material. A complete enclosure of the flat material is not given, which is why a relative movement of two parts of the same inductor associated with an opening and closing of electrical contacts to one another is not required.

The effect of the heating element on the goods to be heated can depend considerably on the distance to the goods, this particularly applies to inductive heating with its interaction with the inductively coupled material. The latter can be the flat material to be processed. In the case of the double-belt press, however, the induction currents are usually generated in the belt material of the double-belt press, which in turn conductively heats the flat material to be processed. The elastic deformability of the pressing rollers of at least one of the pressing roller pairs can lead to the position of a center plane of the flat material running parallel to the transport direction and parallel to the axes of rotation of the pressing rollers shifting perpendicular to said center plane. The shift can take place, for example, when, during pressure build-up, the position of the axis of rotation of one of the pressing rollers of a pressing roller pair in the device remains constant while the axis of rotation of the other pressing roller is shifted.

In order to be able to ensure the best possible reproducible heating of the flat material, it can be particularly advantageous to design the device according to the invention such that means are provided which enable the position of the at least one heating element to be adapted to the position of the center plane.

Such an adaptation can take place by passive tracking of the at least one heating element, for example, by means of spacers between the flat material or the associated belt of the double-belt press and the at least one heating element. Such a spacer can be effected, for example, via a rolling or sliding distance element. At the same time, elastically acting forces can press the at least one heating element in the direction of the flat material or the associated belt of the double-belt press. Guide means can be provided in order to avoid a displacement of the heating elements parallel to the central plane of the flat material.

However, it can also be advantageous to design the device according to the invention such that the distance between the heating elements and the center plane of the flat material is implemented by means for controlling or regulating this distance, Said means can comprise, for example, electric motors and linear guides, wherein the control or regulation are able to be based on sensor values from distance sensors which determine the position of the center plane relative to the axes of rotation of the pressing rollers. This has the advantage that, unlike the passive spacers, changes in the distance can be deliberately brought about in order to be able to additionally influence the degree or the manner of heating.

It can also be advantageous to design the device according to the invention such that at least two pressing roller pairs can be acted upon in a controllable or regulatable manner using press forces that differ from one another. Different pressure profiles can be set in this way, for example, with pressures that change over the course of the pressing region.

The device according to the invention can also be designed such that at least one of the rollers of at least one roller pair comprises a cavity for the passage of a cooling fluid. This protects the elastic material on the circumference of the pressing rollers against potentially harmful high temperatures.

Furthermore, it can be advantageous to design the device according to the invention such that at least one of the pressing rollers of at least one pressing roller pair is protected on the outer circumference by a heat-insulating layer. This provides a further effective protection of the respective pressing roller against the influence of the temperature of the flat material or the belt of the double-belt press. The heat-insulating layer can be a fixed component of the pressing roller. Alternatively, however, the heat-insulating layer can also be formed by a separate band guided around a partial circumference of the roller. This has the advantage that the heat-insulating layer can easily be exchanged and/or, as it rotates, can be guided through a cooling zone spaced apart from the pressing roller. The materials for the heat-insulating layer or the heat-insulating belt can be, for example, textile structures, for example, made of glass, carbon, aramid, basalt or high-performance elastomers such as Kalrez® from DuPont™, or coated metal belts. Low thermal conductivity, high temperature resistance, pressure and abrasion resistance and elasticity at least in the circumferential direction of the pressing roller are advantageous. The latter is particularly advantageous when a deformation of the elastically deformable layer leads to a change in the circumference thereof, which the heat-insulating layer must follow.

Finally, the device according to the invention can be designed such that, during use, a cooling fluid is directed from the outside onto the circumference of the pressing roller and/or onto the end faces of the pressing roller, whereby an additional cooling effect is provided.

Advantageous embodiments of the device according to the invention are depicted below with reference to figures.

Shown schematically are:

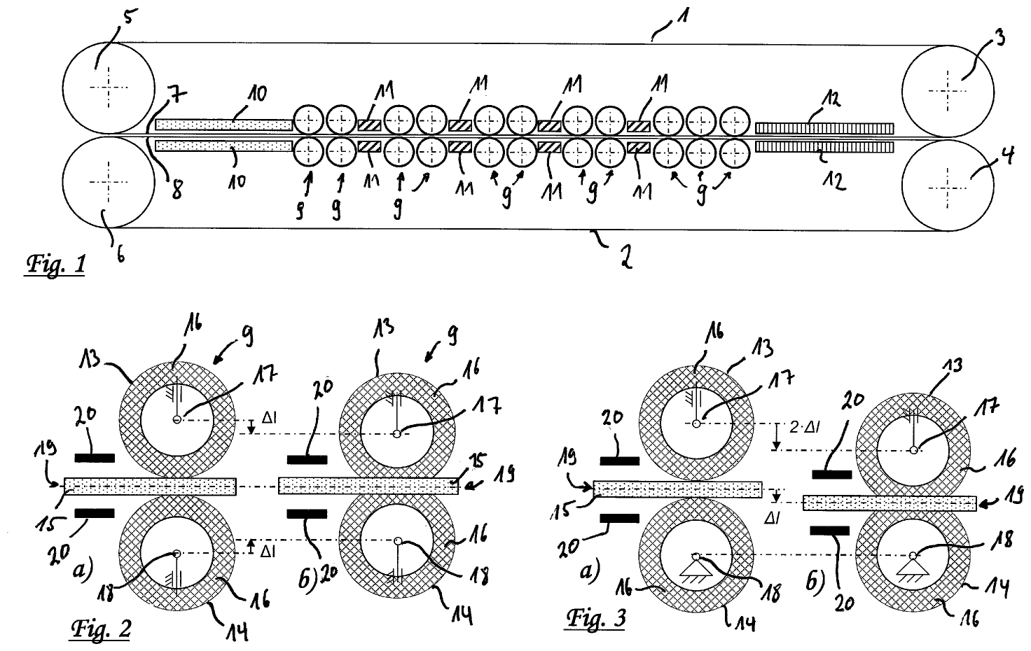

FIG. 1: a double-belt press,

FIG. 2: a pressing roller pair before and after the pressure build-up with heating elements and flat material to be processed without heating means tracking,

FIG. 3: a pressing roller pair before and after the pressure build-up with heating elements and flat material to be processed with heating element tracking,

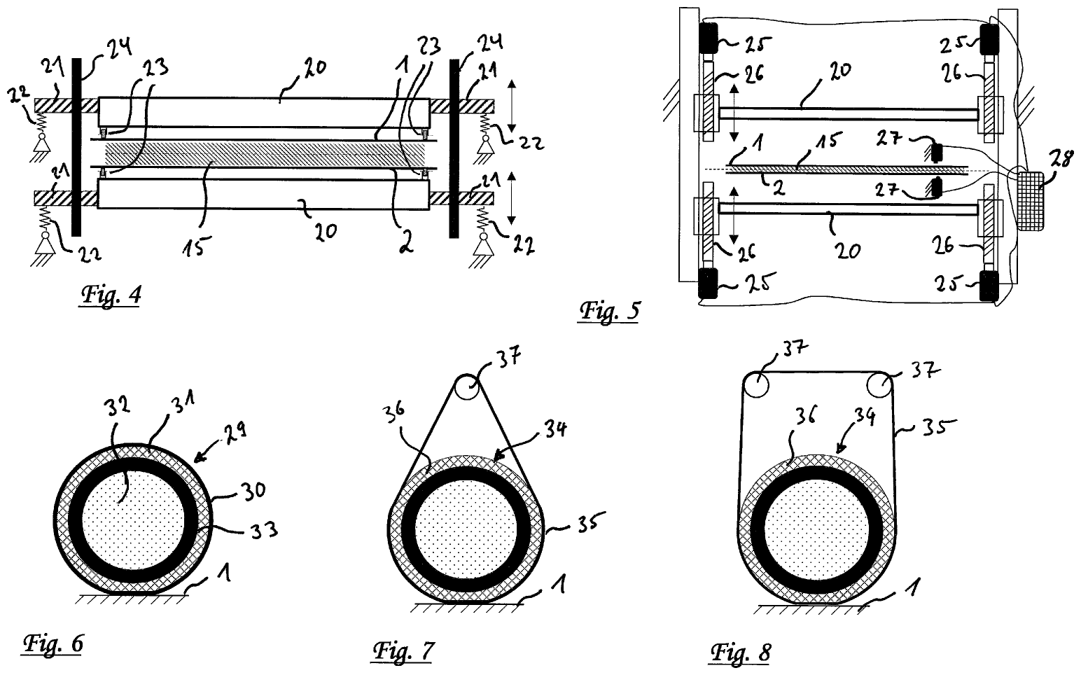

FIG. 4: the principle of heating means tracking with spacers,

FIG. 5: the principle of the motorized heating element tracking,

FIG. 6: pressing roller with integrated heat-insulating layer,

FIG. 7: pressing roller with separate thermal insulation belt guided around a deflection roller,

FIG. 8: pressing roller with separate thermal insulation belt guided around two deflection rollers,

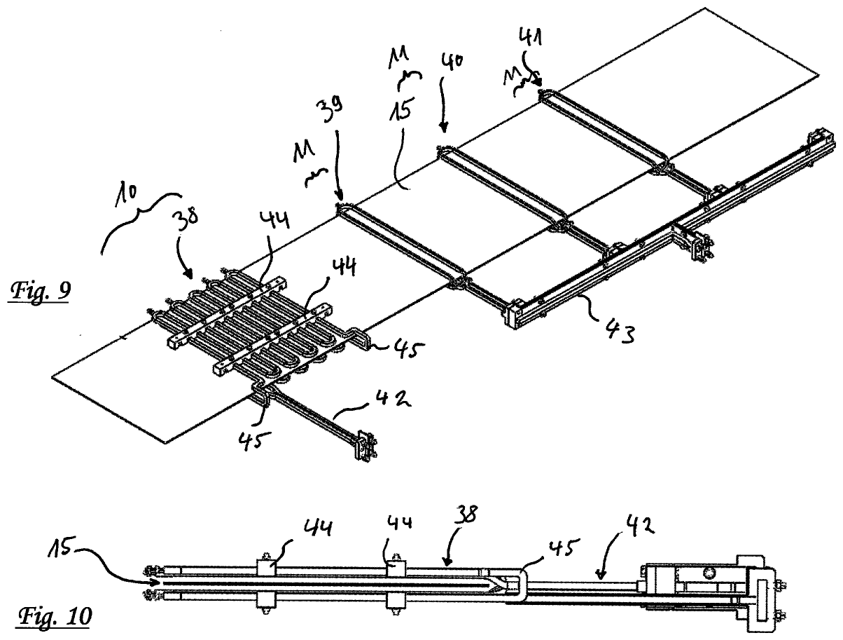

FIG. 9: a perspective view from the side of a workpiece with inductively acting heating elements and

FIG. 10: an inductive heating element encompassing the workpiece in a side view.

FIG. 1 shows schematically in a lateral cross section a double-belt press having an upper press belt 1 and a lower press belt 2. The endless press belts 1 and 2 are each guided around an upper drive roller 3 and lower drive roller 4 and around an upper deflection roller 5 and a lower deflection roller 6, respectively. Flat material to be processed, not shown here, is guided between a working strand 7 of the upper press belt 1 and a working strand 8 of the lower press belt 2, which is carried in a transport direction (from left to right in FIG. 1) by the revolving press belts 1 and 2. A plurality of pressing roller pairs 9 is arranged along the working strands 7 and 8, with which the upper working strand 7 and the lower working strand 8 are pressed against the flat material to be processed, not shown here. Furthermore, heating elements, not shown individually in FIG. 1, are arranged along the working strands 7 and 8 in a main heating zone 10 and in intermediate heating zones 11, which preferably act inductively. In this case, either the material of the press belts 1 and 2 is inductively coupled or the flat material to be processed. A temperature required for processing the flat material can be maintained over a long distance due to the plurality of heating elements and their positioning between the pressing roller pairs 9. The arrangement depicted here of one intermediate heating zone 11 between two pressing roller pairs 9 is only an example. The number of intermediate heating zones 11 and the arrangement of the pressing roller pairs 9 adjacent to the intermediate heating zones 11, for example, individually or in groups of two or more pressing roller pairs 9, can be designed differently depending on the requirements of the operation of the double-belt press. As seen in the transport direction, cooling sections 12 are optionally arranged at the end of the working strands 7 and 8.

FIG. 2 schematically shows a pressing roller pair 9 having an upper pressing roller 13 and a lower pressing roller 14, wherein in a) the situation before application of a pressing power and in b) the situation under a certain pressing power is shown. A workpiece 15 made of flat material to be processed is depicted schematically between the pressing rollers 13 and 14, wherein the press belts 7 and 8 (see FIG. 1) taking the workpiece 15 between them cannot be seen in the illustration. The pressing rollers 13 and 14 comprise an elastically deformable region 16 on their outer circumference. The contact pressure of the two pressing rollers 13 and 14 is built up symmetrically according to FIG. 2, that is, due to the flexibility of the elastically deformable region 16, the axes of rotation 17 and 18 of the pressing rollers 13 and 14 each move the same distance ΔI towards the workpiece 15; the vertical position of a center plane 19 of the workpiece 15 is therefore not changed by the application of the pressing power. FIG. 2 also schematically shows the position of heating elements 20, as they can be provided in the main heating zone 10 or in the intermediate heating zones 11 (see FIG. 1). The distance between these heating elements 20 perpendicular to the center plane 19 remains unchanged despite the shift in the positions of the axes of rotation 17 and 18 which is generated when the pressing power is applied. However, a considerable amount of regulation effort has to be carried out in order to achieve a movement of the pressing roller pair 13 and 14 symmetrical to the center plane 19.

FIG. 3 shows a situation similar to FIG. 2. The same reference numbers relate to the same device elements, so that reference can be made to the description of FIG. 2. The starting position of the pressing rollers 13 and 14 shown in partial figure a) is identical to the starting position in FIG. 2a). One difference is that the axis of rotation 18 of the lower pressing roller 14 is fixed in its position in the arrangement according to FIG. 3. In order to apply the pressing power, only the axis of rotation 17 of the upper pressing roller is thus moved by a distance 2ΔI in the direction of the lower axis of rotation 18. Since the deformation of the pressing rollers 13 or 14 is the same due to the otherwise matching structure, the center plane 19 of the workpiece 15 will move to the lower pressing roller 14 by the distance ΔI. In order to prevent the application of the pressing power from changing the effect of the heating elements 20 on the workpiece 15, provision is made not to change the distance between the heating elements 20 and the center plane 19 and also to move the heating elements 20 by the distance ΔI. With this measure, the advantage of the surface pressure achieved by means of the elastically deformable region 16 is achieved without restriction due to an otherwise only limitedly reproducible effect of the heating elements 20 on the workpiece 15.

FIG. 4 schematically shows, in a cross section perpendicular to the material transport direction, a double-belt press having two heating elements 20, one above and the other below the workpiece 15 and the press belts 1 and 2 receiving the workpiece 15 arranged between them. The heating elements 20 are held on brackets 21 such that the distance between the respective heating element 20 and the associated press belt 1 or 2 is as constant as possible during operation of the double-belt press. Spacers 23 are provided here by way of example for this purpose. In order to be able to follow a possible vertical movement of the respective press belt 1 or 2, the heating elements 20 are pressed with a force in the direction of the associated press belt 1 or 2, which force is symbolized here in each case by a spring element 22. For the upper one of the heating elements 20, said force can also be composed of its weight and a supporting force counteracting gravitation, wherein the supporting force is intended to reduce the load on the upper press belt 1. The spacers 23 are preferably fixed on the respective heating element 20 and can roll off the associated press belt 1 or 2. Of course, sliding spacers can also be provided as an alternative or in addition. Guide elements 24 are provided for guiding the brackets 21.

FIG. 5 also shows in cross section a double-belt press in which, unlike in FIG. 4, the distance between the heating elements 20 and the workpiece 15 arranged between the press belts 1 and 2 is set by means of electric motors 25 and linear guides 26. Sensor values from distance sensors 27, which, for example, measure mechanically, optically or capacitively, serve as the base variable for the control or regulation of the electric motors 25 taking place via a control or regulating device 28.

FIG. 6 shows schematically a pressing roller 29 which presses on the upper press belt 1 and has a heat-insulating layer 30 which is fixedly arranged on the outer circumference thereof and which is applied directly to an elastically deformable region 31 of the pressing roller. The elastically deformable region 31 in turn surrounds a hollow cylinder 33 made of a material that is rigid in comparison, for example, stainless steel. An inner cavity 32 of the hollow cylinder 33 can be used for the flow of a cooling fluid. The elastically deformable region 31, for example, made of silicone, can, for example, have a thickness of 1 to 20 mm, preferably 5 to 15 mm, and a hardness between, for example, 20 Shore A and 65 Shore A, preferably between 50 Shore A and 60 Shore A.

FIG. 7 shows a pressing roller 34 in which the heat-insulating layer is not fixed over the entire circumference but is implemented by a circumferential belt 35 which rests against the elastically deformable region 36 only on part of the circumference thereof and is otherwise guided at a distance from the pressing roller 34 via a deflection roller 37. There is an improved possibility of separate cooling of the belt 35 in the spaced-apart region between the pressing roller 34 and the deflection roller 37. In addition, the belt 35, which is subject to wear, is easily exchangeable. FIG. 8 shows a further variant similar to FIG. 7, in which the belt 35, however, is guided over two deflection rollers 37, whereby a smaller angle of wrap of the belt 35 with the press roller 34 is implemented and a better possibility for cooling can be provided. Reference is made to the description of FIG. 7 for further details.

The fact that the pressing rollers do not necessarily have to be hollow cylinders applies to all embodiments. Other shapes with or without passages for a cooling fluid are also conceivable.

FIG. 9 shows a perspective oblique top view of a workpiece 15 to be processed, wherein of the double belt press, only one inductively acting first heating element 38 having a connection element 42 arranged in a main heating zone 10 (see also FIG. 1) and a respective further inductively acting heating element 39, 40 or 41 having a collective connection element 43 arranged in intermediate heating zones 11 are shown schematically. In the main heating zone 10, the first heating element 38 is guided in a plurality of heating loops on the one hand above the workpiece 15 and on the other hand below the workpiece 15. In the intermediate heating zones 11, the second heating element 39, the third heating element 40 and the fourth heating element 41 each comprise a heating loop above and a heating loop below the workpiece 15. In the intermediate heating zones 11, more than one heating loop in each case and different numbers of heating loops in different intermediate heating zones 11 are also conceivable. The heating elements 39, 40 and 41 can, as shown in FIG. 9, be supplied with power and cooling water jointly via the collective connection element 43 by a preferably controllable alternating current source, not shown here, or without a collective connection element individually directly with one controllable alternating current source each. The latter offers the advantage of individual power regulation and thus individual heating in the heating zones 11.

FIG. 10 shows the first heating element 38 guided around the workpiece 15 with the connection element 42 in a side view. The representations of FIG. 9 and FIG. 10 differ slightly, particularly in connection element 42, but this is not intended to be of any significance here. The connection element 42 is, like the collective connection element 43 (FIG. 9), prepared for contacting a preferably controllable alternating current source, not shown here. The heating loops of the first heating element 38 are mechanically stabilized with respect to one another using two parallel cross connectors 44 made of an electrically insulating material.

The electrical connection between the upper loops and the lower loops of the first heating element 38 is implemented by two transition pieces 45 which are each guided around the edge of the workpiece 15 on the side facing the connection element 42. On the side facing away from the transition pieces 45, the first heating element 38 is open and can thus be guided laterally over the workpiece 15 or the workpiece 15 can be inserted laterally so that maintenance or replacement of the first heating module 38 is possible, even when the workpiece 15 is located in the double-belt press.

The illustrated course of the loops of the first heating element 38 above and below the workpiece leads to the magnetic fields generated during operation of the first heating element 38 being aligned perpendicular to the center plane of the workpiece 15, that is, magnetic transverse fields are generated. Such transverse fields can be technically and economically more efficient when heating flat material, that is, with a large ratio of material width to material thickness, than longitudinal fields running parallel to the center plane.

The statements relating to the first heating element 38 also apply in a corresponding manner to the further heating elements 39, 40 and 41 in the intermediate heating zones 11.

Of course, other design variants for the heating elements are also possible, for example, those in which the part running under the workpiece 15 and the part running above the workpiece can be moved independently of one another at least over a certain distance, for example, in order to be able to implement the embodiment according to FIG. 5. For this purpose, the two parts can be associated with separate connection elements, for example, or the electrical connection between the two components is made via flexible transition pieces or transition pieces that can be changed in length. It should be noted that the vertical movement of the heating elements only requires short distances in the mm or cm range to ensure a largely constant distance between the heating element and the workpiece (see, for example, FIGS. 4 and 5).

### REFERENCE SYMBOLS LIST

| | |
|---|---|
| 1 | upper press belt |
| 2 | lower press belt |
| 3 | upper drive roller |
| 4 | lower drive roller |
| 5 | deflection roller |
| 6 | deflection roller |
| 7 | working strand upper press belt |
| 8 | working strand lower press belt |
| 9 | pressing roller pair |
| 10 | main heating zone |
| 11 | intermediate heating zone |
| 12 | cooling section |
| 13 | upper pressing roller |
| 14 | lower pressing roller |
| 15 | workpiece |
| 16 | elastically deformable region |
| 17 | axis of rotation |
| 18 | axis of rotation |
| 19 | center plane |
| 20 | heating element |
| 21 | bracket |
| 22 | spring element |
| 23 | spacers |
| 24 | guide element |
| 25 | electric motor |
| 26 | linear guide |
| 27 | distance sensors |
| 28 | control or regulating device |
| 29 | pressing roller |
| 30 | heat insulating layer |
| 31 | elastically deformable region |
| 32 | cavity |
| 33 | hollow cylinder |
| 34 | pressing roller |
| 35 | belt |
| 36 | elastically deformable region |
| 37 | deflection roller |
| 38 | first heating element |
| 39 | second heating element |
| 40 | third heating element |
| 41 | fourth heating element |
| 42 | connection element |
| 43 | collective connection element |
| 44 | cross connector |
| 45 | transition piece |

1.-17. (canceled)

18. A device for pressing processing flat material, comprising means for transporting the flat material in a transport direction and at least one pressing roller pair which is stationary in the transport direction and acts on the flat material on both sides, characterized in that,
both pressing rollers of the pressing roller pair or both pressing rollers of at least one of the pressing roller pairs are elastically deformable in the radial direction at least at the circumference of said pressing rollers.

19. The device according to claim 18, characterized in that there are at least two pressing roller pairs arranged one behind the other in the transport direction.

20. The device according to claim 18, characterized in that the device is a double-belt press.

21. The device according to claim 18, characterized by heating means for heating the flat material.

22. The device according to claim 21, characterized in that the heating means act indirectly on the flat material via a double-belt press.

23. The device according to claim 21, characterized in that at least a number of the heating means act inductively.

24. The device according to claim 23, characterized in that at least a number of the heating means are designed to generate magnetic fields which have a predominant magnetic field component oriented perpendicular to a center plane of the flat material.

25. The device according to claim 21, characterized in that the heating means or at least a number of the heating means have a meandering course at least in sections.

26. The device according to claim 21, characterized in that at least a number of the heating means are designed to encompass a section of the fiat material to be heated in a shape.

27. The device according to claim 21, characterized by means for controlling or regulating a distance between the heating means and a center plane of the flat material running parallel to the transport direction and parallel to the axes of rotation of the pressing rollers.

28. The device according to claim 21, characterized by spacers to ensure a constant distance between the heating means and a center plane of the flat material running parallel to the transport direction.

29. The device according to claim 18, characterized in that at least two pressing roller pairs can be acted upon in a controllable or regulatable manner with different pressing forces.

30. The device according to claim 18, characterized in that at least one of the pressing rollers of at least one pressing roller pair comprises a cavity for the passage of a cooling fluid.

31. The device according to claim 18, characterized in that at least one of the pressing rollers of at least one roller pair is protected on the outer circumference by a heat-insulating layer.

32. The device according to claim 31, characterized in that the heat-insulating layer is part of the pressing roller.

33. The device according to claim 31, characterized in that the heat-insulating layer is formed by a separate belt guided around part of the circumference of the roller.

34. The device according to claim 18, characterized by cooling means which, during use, direct a cooling fluid from the outside onto the circumference of the pressing roller and/or onto the end faces of the pressing roller.
